(19) United States
(12) Patent Application Publication
(10) Pub. No.: US 2014/0238212 A1
(43) Pub. Date: Aug. 28, 2014

(54) SAW GUIDE

(71) Applicant: Kevin Lee Strand, Montevideo, MN (US)

(72) Inventor: Kevin Lee Strand, Montevideo, MN (US)

(21) Appl. No.: 13/774,924

(22) Filed: Feb. 22, 2013

(51) Int. Cl. B27B 9/04; B23D 59/00; B23D 45/16

(52) U.S. Cl. CPC B27B 9/04; B23D 45/16; B23D 59/00
USPC 83/520; 83/821; 30/374

(57) ABSTRACT

A saw guide is attached to a circular saw to help make straight, accurate cuts along a line a desired distance from an edge of an object, such as a piece of wood. The guide includes a fence that can fold up by one or more hinges to store the fence out of the way when not in use, allowing the saw to be used like a conventional saw. The fence can be pivoted down, extending at about a 90 degree angle from the saw base, generally parallel to the radius of the saw blade. The distance from the saw blade and the fence can be adjusted and locked into place to make a cut having a desired width.

### BACKGROUND OF THE INVENTION

The present invention relates to saw guides and, more particularly, to a saw guide that attaches to a saw and provides an edge to guide the saw in a straight cut.

To make straight cuts in wood, various tools can be used. A table saw is a useful tool for making long, straight cuts in wood by guiding the wood along a fixed guide and across a rotating blade. A table saw, however, is a large piece of equipment that many homeowners may not own and, if they do own such equipment, it can be difficult to use in many circumstances, such as in confined spaces or where the tool must be carried for use, such as on a roof.

A power circular saw is a less expensive, more portable alternative for making cuts in wood. However, these saws can be difficult to handle when trying to cut straight and precise finish cuts.

To help users cut straight cuts, guides are often provided in various forms. Many conventional guides are difficult to set up, can be big and clumsy to use, or can be ineffective. For example, one example of a conventional guide includes an adjustable T-shaped bar that can attach to the saw. This bar provides a short edge along which the saw is guided. This short edge is inefficient to prevent the saw from drifting off a desired cutting line. Moreover, many such guides are only loosely attached to the saw, or can become loose during use.

In other attempts to assist users make straight cuts, laser guides can be provides on saws. These laser guides, however, still require skill of the user to keep the saw on the desired cutting path.

As can be seen, there is a need for an improved saw guide that can provide an extended, adjustable edge for making cuts and that can be easily stored out of the way when not in use.

### SUMMARY OF THE INVENTION

In one aspect of the present invention, a saw guide comprises a guide plate having a blade slot cut along a first side thereof; slots cut along an upper region and a lower region of the guide plate, the slots extending generally perpendicular to the blade slot; a raised ledge formed along a second, opposite side of the guide plate, the slots extending into the raised ledge; and a hinge guide slidable and securable into a desired position along the slots, the hinge guide extending from a bottom surface of the guide plate.

In another aspect of the present invention, a circular saw comprises a guide plate forming a base of the circular saw, the guide plate including a blade slot cut along a first side thereof; slots cut along an upper region and a lower region of the guide plate, the slots extending generally perpendicular to the blade slot; a raised ledge formed along a second, opposite side of the guide plate, the slots extending into the raised ledge; and a hinge guide slidable and securable into a desired position along the slots, the hinge guide extending from a bottom surface of the guide plate.

These and other features, aspects and advantages of the present invention will become better understood with reference to the following drawings, description and claims.

### BRIEF DESCRIPTION OF THE DRAWINGS

FIG. 1 is a back view of a saw guide, mounted on a saw, in use, according to an exemplary embodiment of the present invention;

FIG. 2 is a perspective view of the saw guide of FIG. 1;

FIG. 3 is a front view of the saw guide of FIG. 1;

FIG. 4 is a bottom perspective view of the saw guide of FIG. 1;

FIG. 5 is a bottom detailed perspective view of the saw guide of FIG. 1 with the hinged guide in an open configuration;

FIG. 6 is another bottom detailed perspective view of the saw guide of FIG. 1 with the hinged guide in an open configuration; and

FIG. 7 is a cross-sectional view taken along line 7-7 of FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a saw guide that is attached to a circular saw to help make straight, accurate cuts along a line a desired distance from an edge of an object, such as a piece of wood. The guide includes a fence that can fold up by one or more hinges to store the fence out of the way when not in use, allowing the saw to be used like a conventional saw. The fence can be pivoted down, extending at about a 90 degree angle from the saw base, generally parallel to the radius of the saw blade. The distance from the saw blade and the fence can be adjusted and locked into place to make a cut having a desired width.

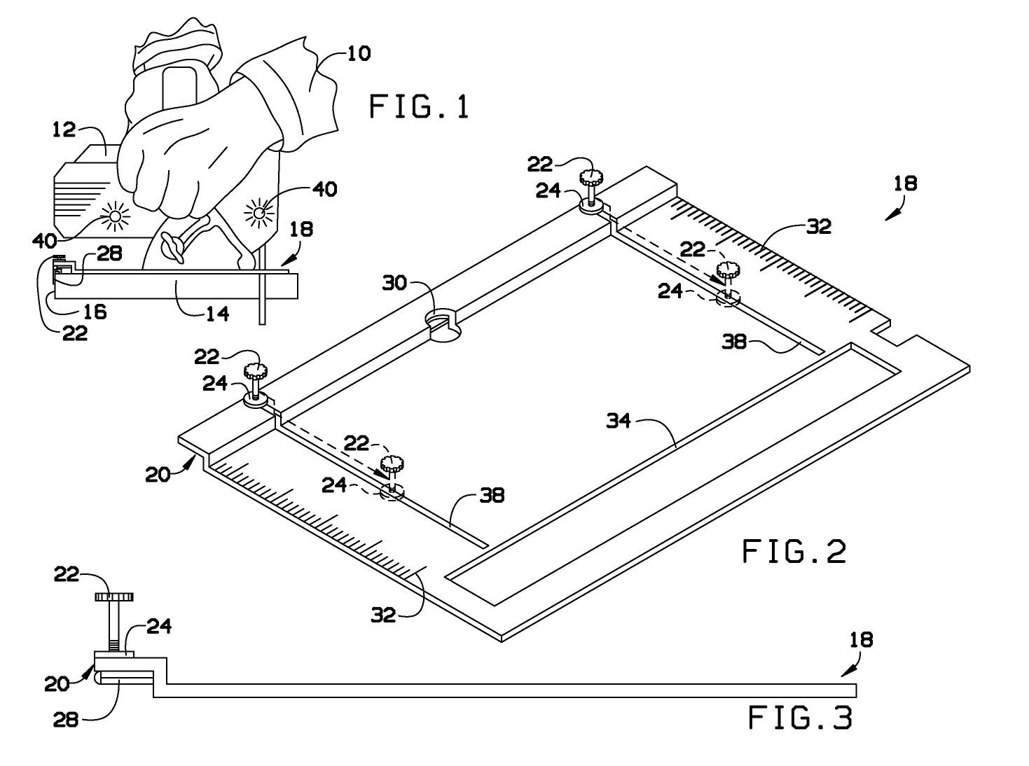

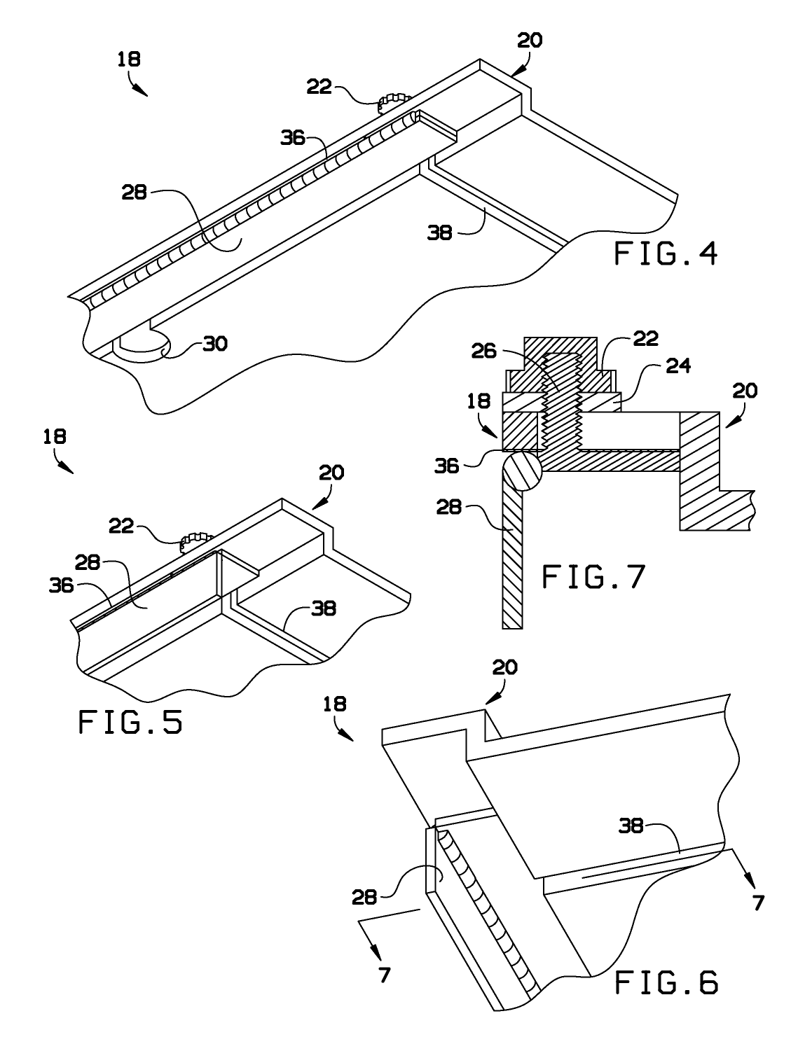

Referring to FIGS. 1 through 7, a circular saw 12 can include a guide plate 18 supporting the circular saw 12 and through which a saw blade can pass. The guide plate 18 can include a blade slot 34 and slots 38 disposed along a top and bottom region of the guide plate 18. The slots 38 can be disposed generally perpendicular to the blade slot 34.

A ledge 20 can be formed along one side of the guide plate 18. Typically, the ledge 20 is formed along the left hand side (as determined from above the saw when the saw is facing a forward, or cutting direction) of the guide plate 18. The ledge 20 can be a raised L-shaped region having a height as least as high as a folded, closed hinge guide 28 so that the hinge guide 28 can be disposed within the ledge 20, as shown in FIG. 3, without interfering with the operation of the circular saw 12 by the user 10. The slots 38 cut in the base plate 18 continue onto the ledge 20.

The hinge guide 28 has threaded members 26 extending from a top edge thereof. The threaded members 26 can extend through the slots 38 and be secured against the guide plate 18 with a knob 22 and a washer 24 on each threaded member 26. The hinge guide 28 can be moved from the ledge 20 to any position along the slots 38. The knobs 22 can be tightened to secure the hinge guide 28 to a particular location. A user can open the hinge guide 28 (as shown in FIGS. 5 through 7) and place the guide along the edge of an item to be cut, such as lumber 14. The circular saw 12 can then be moved along the lumber 14 to create a straight cut at a dimension that is the size from where the hinge guide 28 is positioned to the edge of the blade of the circular saw 12.

A magnetic strip 36 can be disposed in the ledge 20. The magnetic strip 36 can hold the hinge guide 28 in a closed position. A finger hole 30 can be positioned along the ledge to allow a user to insert a finger therein, press against the hinge guide 28, and open the hinge guide 28 against the force of the magnetic strip 36.

The guide plate 18 can be, for example, about 7 to about 8 inches wide, typically about 7¼ inches wide, suitable for a user that desires to make a rip cut along a length of 6-inch dimensional lumber, such as 2-by-6 lumber. In some embodiments, the guide plate 18 can be up to about 9 to about 10 inches wide, suitable for cutting 8-inch dimensional lumber, such as 2-by-8 lumber.

A set of measurement markings 32 can be disposed along front and rear edges of the guide plate 18. The measurement markings 32 can correspond to a width of the cut to be made with the circular saw 12. In some embodiments, the knob 22 can include a marker to point toward the measurement markings 32, allowing a user to accurately set the knobs 22, and thus the hinge guide 28. In some embodiments, grooves can be disposed along the slot 38 to allow the knob 22 to sit into to accurately lock into specific cutting widths.

In some embodiments, the circular saw 12 can be formed with one or more lights 40 disposed thereupon. The lights 40 can be LED lights, for example, that shine in front of the circular saw 12.

The guide plate 18 can be designed as replacement for existing circular saws or may be made as an integral component of a circular saw. The guide plate 18 can mount the saw in various configurations, as may be realized by those skilled in the art. While the Figures show the saw blade extending perpendicular through the guide plate 18, the guide plate can be angled to allow the saw to make cuts on an angle, similar to conventional circular saws.

While the Figures show a single guide hinge 28, this component could be formed as two separate guide hinges, with each connected to corresponding slots 38.

It should be understood, of course, that the foregoing relates to exemplary embodiments of the invention and that modifications may be made without departing from the spirit and scope of the invention as set forth in the following claims.

What is claimed is:

1. A saw guide comprising:
a guide plate having a blade slot cut along a first side thereof;
slots cut along an upper region and a lower region of the guide plate, the slots extending generally perpendicular to the blade slot;
a raised ledge formed along a second, opposite side of the guide plate, the slots extending into the raised ledge; and
a hinge guide slidable and securable into a desired position along the slots, the hinge guide extending from a bottom surface of the guide plate.

2. The saw guide of claim 1, further comprising bolts attached to the hinge guide and extending through the slots.

3. The saw guide of claim 2, further comprising knobs threadably secured to ends of the bolts for securing the hinge guide to a desired position along the slots.

4. The saw guide of claim 1, further comprising a magnetic strip disposed in the raised ledge for securing the hinge guide in a closed configuration.

5. The saw guide of claim 1, further comprising measurement markings disposed along an upper edge and a lower edge of the guide plate.

6. The saw guide of claim 4, further comprising a finger hole disposed in the raised ledge permitting visualization of the hinge guide when the hinge guide is in the closed configuration.

7. A circular saw comprising:
a guide plate forming a base of the circular saw, the guide plate including:
a blade slot cut along a first side thereof;
slots cut along an upper region and a lower region of the guide plate, the slots extending generally perpendicular to the blade slot;
a raised ledge formed along a second, opposite side of the guide plate, the slots extending into the raised ledge; and
a hinge guide slidable and securable into a desired position along the slots, the hinge guide extending from a bottom surface of the guide plate.

8. The circular saw of claim 7, further comprising:
bolts attached to the hinge guide and extending through the slots; and
knobs threadably secured to ends of the bolts for securing the hinge guide to a desired position along the slots.

9. The circular saw of claim 7, further comprising
a magnetic strip disposed in the raised ledge for securing the hinge guide in a closed configuration; and
a finger hole disposed in the raised ledge permitting visualization of the hinge guide when the hinge guide is in the closed configuration.

10. The circular saw of claim 7, further comprising measurement markings disposed along an upper edge and a lower edge of the guide plate.

11. The circular saw of claim 7, further comprising lights operable to illuminate an area in front of the circular saw during use thereof.

12. The circular saw of claim 11, wherein the lights are light emitting diodes.
